(19) United States
(12) Patent Application Publication
(10) Pub. No.: US 2026/0100820 A1
(43) Pub. Date: Apr. 9, 2026

(54) SECURE MULTI-QR CODE DATA ENCODING AND RETRIEVAL WITH ASYMMETRIC ENCRYPTION

(71) Applicant: NVENTR IP, LLC, Las Vegas, NV (US)

(72) Inventor: Ajit Singh CHADHA, Santa Monica, CA (US)

(21) Appl. No.: 19/348,557

(22) Filed: Oct. 2, 2025

Related U.S. Application Data
(60) Provisional application No. 63/702,341, filed on Oct. 2, 2024.

(51) Int. Cl. H04L 9/08; G06K 19/06; H04L 9/00; H04L 9/06

(52) U.S. Cl. CPC H04L 9/0825; G06K 19/06037; H04L 9/0643; H04L 9/50

(57) ABSTRACT

A method for securely encoding and encrypting data using QR codes includes receiving input data from a user. The method also includes encrypting the input data using asymmetric encryption to create an encrypted payload. The method further includes fragmenting the encrypted payload into multiple data segments. The method also includes encoding each data segment into a corresponding QR code. The method still further includes assigning a unique identifier to each QR code for tracking and reassembly purposes.

### CROSS-REFERENCE TO RELATED APPLICATION

The present application claims the benefit of U.S. Provisional Patent Application No. 63/702,341, filed on Oct. 2, 2024, and titled “SECURE MULTI-QR CODE DATA ENCODING AND RETRIEVAL WITH ASYMMETRIC ENCRYPTION,” the disclosure of which is expressly incorporated by reference in its entirety.

### FIELD OF THE DISCLOSURE

Aspects of the present disclosure relate generally to secure data encoding, transmission, and storage, more particularly, using QR codes for data retrieval across different platforms.

### BACKGROUND

Encrypting data into QR codes involves combining two key technologies: encryption and QR code encoding. QR codes, or Quick Response codes, are matrix barcodes that can store various types of information, including text, URLs, or binary data, in a compact, machine-readable format. They have become popular for encoding information that can be easily scanned and interpreted by devices such as smartphones. However, standard QR codes do not inherently provide security, making the data vulnerable to unauthorized access or tampering when used for sensitive information.

Encryption complements QR code encoding by transforming plaintext data into ciphertext through cryptographic algorithms. This ensures that only authorized entities possessing the appropriate decryption key can recover the original information. When encryption is applied prior to embedding data in QR codes, the resulting encoded data retains the portability and accessibility of QR technology while preventing unauthorized access. The combination of encryption and QR code encoding supports secure transmission and storage of sensitive information, including personal, medical, financial, and contractual records, while maintaining the flexibility of use across different platforms and devices.

### SUMMARY

In some aspects of the present disclosure, a method for securely encoding and encrypting data using QR codes includes receiving input data from a user and encrypting the input data using asymmetric encryption to generate an encrypted payload. The method further includes fragmenting the encrypted payload into multiple data segments, encoding each data segment into a corresponding QR code, and assigning a unique identifier to each QR code for tracking and reassembly.

Other aspects of the present disclosure are directed to an apparatus. The apparatus includes means for receiving input data from a user, means for encrypting the input data using asymmetric encryption to generate an encrypted payload, means for fragmenting the encrypted payload into multiple data segments, means for encoding each data segment into a corresponding QR code, and means for assigning a unique identifier to each QR code for tracking and reassembly.

In other aspects of the present disclosure, a non-transitory computer-readable medium with program code recorded thereon is disclosed. The program code is executed by one or more processors and includes program code to receive input data from a user, program code to encrypt the input data using asymmetric encryption to generate an encrypted payload, program code to fragment the encrypted payload into multiple data segments, program code to encode each data segment into a corresponding QR code, and program code to assign a unique identifier to each QR code for tracking and reassembly.

Other aspects of the present disclosure are directed to a system. The system includes one or more processors and one or more memories coupled with the one or more processors. The memory stores processor-executable code that, when executed by the one or more processors, causes the system to receive input data from a user, encrypt the input data using asymmetric encryption to generate an encrypted payload, fragment the encrypted payload into multiple data segments, encode each data segment into a corresponding QR code, and assign a unique identifier to each QR code for tracking and reassembly.

In some aspects of the present disclosure, a method for verifying data authenticity in a multi-QR code encryption system includes encrypting input data to generate an encrypted data payload, fragmenting the encrypted data payload into a plurality of data segments, and encoding each of the plurality of data segments into a corresponding QR code. The method further includes generating a cryptographic hash of the encrypted data payload prior to encoding, storing the cryptographic hash on a blockchain to create a decentralized and tamper-proof record of the encrypted data payload, and reassembling, upon retrieval of the plurality of QR codes, the encrypted data payload from the plurality of data segments.

Other aspects of the present disclosure are directed to an apparatus. The apparatus includes means for encrypting input data to generate an encrypted data payload, means for fragmenting the encrypted data payload into a plurality of data segments, means for encoding each of the plurality of data segments into a corresponding QR code, means for generating a cryptographic hash of the encrypted data payload, means for storing the cryptographic hash on a blockchain, and means for reassembling the encrypted data payload from the plurality of data segments upon retrieval.

In other aspects of the present disclosure, a non-transitory computer-readable medium with program code recorded thereon is disclosed. The program code is executed by one or more processors and includes program code to encrypt input data to generate an encrypted data payload, program code to fragment the encrypted data payload into a plurality of data segments, program code to encode each of the plurality of data segments into a corresponding QR code, program code to generate a cryptographic hash of the encrypted data payload, program code to store the cryptographic hash on a blockchain, and program code to reassemble the encrypted data payload from the plurality of data segments upon retrieval.

Other aspects of the present disclosure are directed to a system. The system includes one or more processors and one or more memories coupled with the one or more processors. The memory stores processor-executable code that, when executed by the one or more processors, causes the system to encrypt input data to generate an encrypted data payload, fragment the encrypted data payload into a plurality of data segments, encode each of the plurality of data segments into a corresponding QR code, generate a cryptographic hash of the encrypted data payload, store the cryptographic hash on a blockchain, and reassemble, upon retrieval, the encrypted data payload from the plurality of data segments.

In some aspects of the present disclosure, a method for securely encoding, transmitting, and retrieving data using QR codes includes receiving input data from a user and encrypting the input data using asymmetric encryption to generate an encrypted data payload. The method further includes fragmenting the encrypted data payload into a plurality of data segments, encoding each of the plurality of data segments into a corresponding QR code, and assigning a unique identifier to each QR code to facilitate tracking and order-independent reassembly. The method also includes reassembling the encrypted data payload from the plurality of QR codes upon retrieval and decrypting the reassembled encrypted data payload using a private key associated with an intended recipient to recover the original input data.

Other aspects of the present disclosure are directed to an apparatus. The apparatus includes means for receiving input data from a user, means for encrypting the input data using asymmetric encryption to generate an encrypted data payload, means for fragmenting the encrypted data payload into a plurality of data segments, means for encoding each of the plurality of data segments into a corresponding QR code, and means for assigning a unique identifier to each QR code to facilitate tracking and reassembly. The apparatus also includes means for reassembling the encrypted data payload from the plurality of QR codes upon retrieval and means for decrypting the reassembled encrypted data payload using a private key associated with an intended recipient to recover the original input data.

In other aspects of the present disclosure, a non-transitory computer-readable medium having program code recorded thereon is disclosed. The program code is executed by one or more processors and includes program code to receive input data from a user, program code to encrypt the input data using asymmetric encryption to generate an encrypted data payload, program code to fragment the encrypted data payload into a plurality of data segments, program code to encode each of the plurality of data segments into a corresponding QR code, program code to assign a unique identifier to each QR code to facilitate tracking and reassembly, program code to reassemble the encrypted data payload from the plurality of QR codes upon retrieval, and program code to decrypt the reassembled encrypted data payload using a private key associated with an intended recipient to recover the original input data.

Other aspects of the present disclosure are directed to a system. The system includes one or more processors and one or more memories coupled with the one or more processors. The memory stores processor-executable code that, when executed by the one or more processors, causes the system to receive input data from a user, encrypt the input data using asymmetric encryption to generate an encrypted data payload, fragment the encrypted data payload into a plurality of data segments, encode each of the plurality of data segments into a corresponding QR code, assign a unique identifier to each QR code to facilitate tracking and reassembly, reassemble the encrypted data payload from the plurality of QR codes upon retrieval, and decrypt the reassembled encrypted data payload using a private key associated with an intended recipient to recover the original input data.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram illustrating an example of a system for securely encoding, transmitting, and retrieving data using multiple QR codes, in accordance with aspects of the present disclosure.

FIG. 2 is a diagram illustrating an example of a hardware implementation for a system, in accordance with various aspects of the present disclosure.

FIGS. 3A, 3B, and 3C illustrate an example workflow for securely creating, encrypting, encoding, sharing, and retrieving data, such as forms, documents, or files, using multiple QR codes and blockchain-based verification, in accordance with various aspects of the present disclosure.

FIG. 4 is a flow diagram illustrating an example of a process for securely encoding, transmitting, and retrieving data using multiple QR codes, in accordance with various aspects of the present disclosure.

FIG. 5 is a flow diagram illustrating an example of a process for securely encoding, transmitting, and verifying the authenticity of data using multiple QR codes and blockchain technology, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced.

The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration. ” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

Conventional methods of converting human-readable printed forms to machine-readable formats rely heavily on Optical Character Recognition (OCR). OCR is inherently error-prone because it attempts to visually interpret characters and symbols, often misidentifying them based on font, alignment, or print quality. Humans cannot feasibly perform this translation at scale because even manual data entry is slow, inconsistent, and highly susceptible to human error when dealing with complex data structures. For example, nested tables, multi-level key-value pairs, or JSON schemas cannot be reliably re-created by a human operator without risk of misplacement or omission. These shortcomings demonstrate that OCR and manual alternatives fail to deliver the precision and scalability required for modern digital workflows.

Current methods of transmitting and storing sensitive data, such as forms and contractual documents, also suffer from inadequate security. Standard QR codes can encode data but do not provide intrinsic mechanisms for encryption or fragmentation. Sensitive datasets encoded in such QR codes are vulnerable to interception or tampering, and humans cannot detect such tampering by inspection because encrypted payloads appear visually indistinguishable from valid codes. Without automated cryptographic protection, data transmitted or stored in this way is inherently insecure.

Moreover, QR codes are typically used for small, simple payloads such as URLs or contact details, rather than complex or voluminous datasets. Humans cannot compress or partition large datasets into QR-readable fragments in a way that preserves integrity and ensures reassembly. Attempting such a process manually would be impractical, error-ridden, and incapable of scaling. As a result, traditional QR applications fail to extend to enterprise-level or mission-critical use cases that demand both high capacity and high fidelity.

Ensuring data authenticity and integrity is another domain where human oversight is insufficient. In industries such as healthcare, finance, or law, even minor data tampering can have severe consequences. A human reviewer cannot verify whether a dataset has been cryptographically altered without advanced tools. Standard QR codes and printed forms provide no immutable audit trail, leaving authenticity unverifiable. Without a decentralized and automated verification method, there is no reliable technological safeguard against undetected manipulation.

Large datasets also present storage and transmission challenges. Paper records consume significant physical space, and electronic records demand costly digital storage infrastructure. While QR codes are compact, they are not conventionally employed to encode large or complex datasets because of error risks during scanning or reassembly. Human intervention cannot mitigate these risks at scale, underscoring the need for a technical solution that combines compactness with resilience.

In systems involving multiple parties across different organizations or geographic regions, maintaining synchronized and verifiable data records becomes even more difficult. Humans cannot practically coordinate cross-party audits without a trusted technological framework. Existing systems lack a transparent, decentralized method to verify authenticity and ensure consensus on data history, leading to inconsistencies and disputes.

Various aspects of the present disclosure provide a technological improvement by integrating encryption, QR code encoding, and blockchain verification into a unified system for secure data management. In operation, data is first encrypted using asymmetric cryptography to ensure that only authorized recipients can access the underlying information. The encrypted payload is then fragmented and distributed across multiple QR codes using a proprietary algorithm that supports redundancy and order-independent reassembly. To guarantee authenticity and integrity, a cryptographic hash of the original payload is recorded on a blockchain, creating an immutable audit trail without requiring storage of the data itself. Together, these features establish a secure, compact, and verifiable mechanism for encoding, transmitting, and retrieving complex datasets across analog and digital platforms.

The disclosed system provides a technological improvement by combining asymmetric encryption, multi-QR fragmentation, and blockchain hashing to form a secure, scalable, and error-resistant data management framework.

The system also enables error-free conversion between analog QR-encoded forms and digital machine-readable structures, eliminating reliance on OCR and manual entry.

Complex data schemas, such as JSON or hierarchical tables, can be accurately preserved through encoding and decoding without requiring human intervention or correction. This ensures not only data security but also precision in translating complex datasets between formats.

By condensing large datasets into a compact and scannable QR code format, the system reduces both physical and digital storage burdens while maintaining secure, accurate, and retrievable data. In this way, the disclosed technology goes beyond simply protecting information; it establishes a new paradigm for efficient, secure, and verifiable data exchange that is not possible through human processes or existing digital methods.

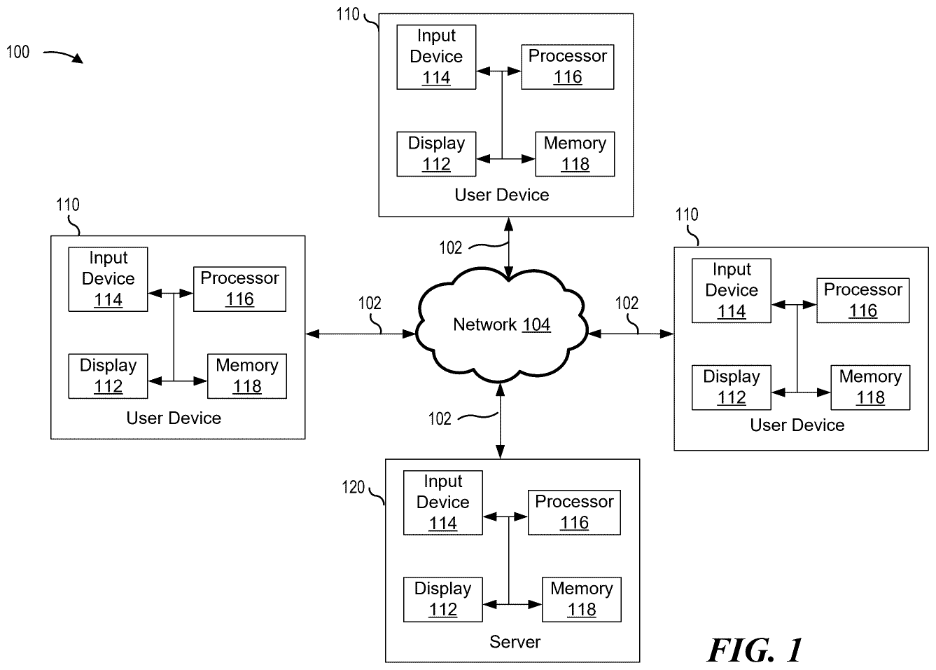

FIG. 1 is a block diagram illustrating an example of a system 100 for securely encoding, transmitting, and retrieving data using multiple QR codes, in accordance with aspects of the present disclosure. As shown in the example of FIG. 1, the system 100 may include one or more user devices 110 and one or more servers 120 connected over a network 104 via one or more communication links 102. For ease of explanation, only a single server 120 is shown. The communication links 102 may be wired and/or wireless, enabling secure data exchange between the user devices 110 and the server 120.

The network 104 may include the Internet or, alternatively, any suitable communication infrastructure such as an intranet, wide-area network (WAN), local-area network (LAN), wireless network, digital subscriber line (DSL) network, frame relay network, asynchronous transfer mode (ATM) network, or virtual private network (VPN). The communication links 102 may be any type of link suitable for transferring encrypted and encoded data, including network links, dial-up links, wireless links (e.g., Wi-Fi, satellite, or cellular), and/or hard-wired links.

The server 120 may be implemented as a computing system configured to host encryption algorithms, QR code generation and decoding models, and blockchain integration modules. In some examples, the server 120 may also host machine learning models for optimizing QR code fragmentation, error correction, and recovery of encrypted payloads. Specifically, the server 120 may execute computer-readable instructions implementing a multi-fragmentation algorithm that distributes encrypted data across multiple QR codes, and a blockchain hashing module that records cryptographic hashes to provide immutable authenticity verification.

Each user device 110 may be any computing device, such as a personal computer, smartphone, or tablet, capable of interacting with the system via wired or wireless communication. A user device 110 may be used to input data for encryption and encoding into QR codes, as well as to scan and decode QR codes for data retrieval. In some examples, different user devices 110 may be operated by different parties in a secure workflow.

Each user device 110 may include one or more processors 116, a memory 118, a display 112, and an input device 114 within a housing. The processors 116, memory 118, display 112, and input device 114 may be interconnected via a bus architecture. The memory 118 may include volatile and non-volatile memory and may store program instructions that, when executed by the processor 116, cause the user device to perform QR code scanning, data input, and secure interaction with the server 120. The input device 114 may be used to navigate a graphical interface for QR code generation, form creation, or data retrieval.

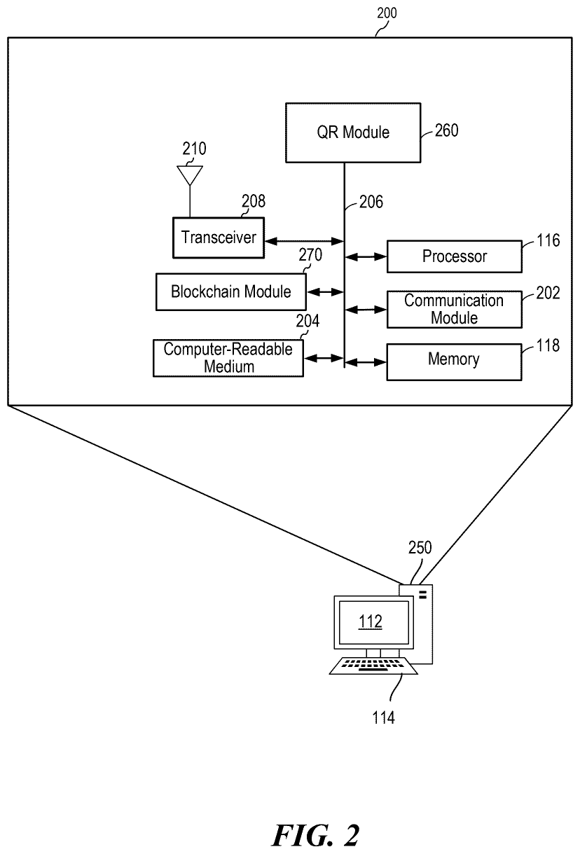

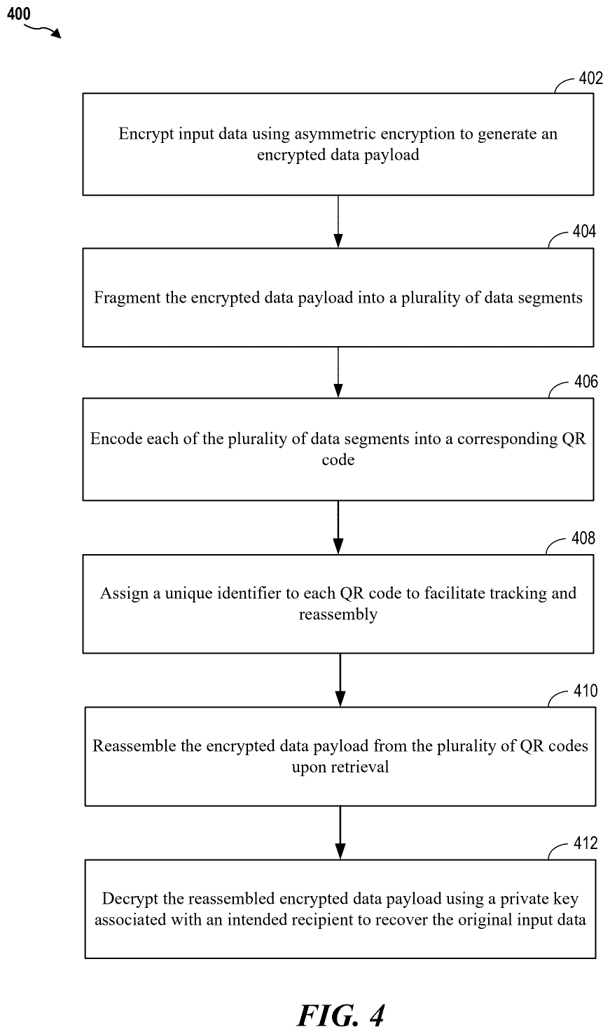

The server 120 may likewise include one or more processors 116, memory 118, display 112, and input device 114 within a housing. The memory 118 and/or storage devices associated with the server 120 may store program instructions that, when executed by the processor 116, implement encryption, multi-QR fragmentation, blockchain hash recording, and secure data transmission functions. In some examples, the server 120 may execute the QR code module 260 (described in connection with FIG. 2) or process workflows such as process 400 (described in connection with FIG. 4). By integrating encryption, QR encoding, and blockchain verification into a unified architecture, the server 120 provides a secure, scalable, and error-resistant framework for managing sensitive data.

The architecture illustrated in FIG. 1 achieves a concrete technical effect by enabling secure, error-free, and verifiable translation of data across analog and digital domains. By integrating asymmetric encryption with multi-QR fragmentation and blockchain-based authenticity verification, the system ensures that sensitive data can be encoded, transmitted, and retrieved without reliance on error-prone human processes such as OCR or manual entry. The distributed QR structure provides resilience against data loss by allowing accurate reassembly even if some codes are damaged or missing, while blockchain hashing delivers a tamper-proof audit trail that cannot be replicated by conventional systems. Collectively, the elements of system 100 establish a technological improvement in secure data management, providing accuracy, integrity, and efficiency across diverse platforms and use cases.

FIG. 2 is a diagram illustrating an example of a hardware implementation for a system 200, in accordance with various aspects of the present disclosure. The system 200 may be a component of a device 250. The device 250 may also be referred to as a QR code device 250 (hereinafter used interchangeably). The device 250 may be an example of a user device 110 or a server 120 described with reference to FIG. 1. As shown in the example of FIG. 2, the device 250 may include a display 112 and an input device 114 (e.g., a keyboard or touchscreen). In some examples, one or more modules of the system 200 may be configured to perform operations and implement one or more elements associated with one or more processes, such as the process 400 described with reference to FIG. 4.

The system 200 may be implemented with a bus architecture, represented generally by a bus 206. The bus 206 may include any number of interconnecting buses and bridges depending on the specific application of the system 200 and the overall design constraints. The bus 206 links together various circuits, including one or more processors and/or hardware modules, represented by a processor 116, a communication module 202, and a memory 118. The bus 206 may also link other circuits such as timing sources, peripherals, voltage regulators, and power management circuits, which are well known in the art, and therefore will not be described further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. In some implementations, the transceiver 208 may support multiple communication protocols, including Wi-Fi, cellular (e.g., LTE, 5G), Bluetooth, and satellite communication, enabling secure interaction between devices 110 and servers 120.

As shown in the example of FIG. 2, the system 200 may include a QR module 260 for securely encoding, transmitting, and retrieving data using multiple QR codes. In some examples, the QR module 260 may perform operations such as encrypting payloads, fragmenting encrypted data across multiple QR codes, assigning metadata for order-independent scanning, and reassembling payloads using error-correction techniques. The QR module 260 may also implement one or more operations associated with the process 400 described with reference to FIG. 4. In certain implementations, the QR module 260 may include computational intelligence elements, such as neural networks, fuzzy logic, or other machine learning algorithms to optimize fragmentation, encoding, and error recovery. One or more of the modules 116, 118, 202, 204, 208, and 260 may also incorporate such intelligence elements, and in some arrangements, functions may be distributed across modules or combined into a single module.

The system 200 further includes a blockchain module 270, coupled to the processor 116 and communication module 202, configured to generate cryptographic hashes of encoded payloads and record them on a public or private blockchain. The blockchain module 270 provides a tamper-proof verification layer that ensures data authenticity without storing large datasets on-chain. The processor 116 is coupled to the computer-readable medium 204 and performs processing, including the execution of software stored on the medium 204 to provide functionality according to the disclosure. The software, when executed by the processor 116, causes the system 200 to perform the functions of one or more modules, including secure QR encoding, payload reassembly, and blockchain verification. The computer-readable medium 204 may also be used for storing data manipulated by the processor 116 during execution of the software. For example, working in conjunction with one or more of the other modules 116, 118, 202, 204, 208, 260, and 270, the processor 116 may perform operations including those of the process 400 described with reference to FIG. 4.

As indicated above, FIGS. 1 and 2 are provided as examples. Other examples may differ from what is described with regard to FIGS. 1 and 2.

Various aspects of the present disclosure are directed to a system that secures data both at rest and in transit by encrypting it, encoding it into multiple QR codes, and distributing the encrypted payload across those QR codes. This layered approach provides both confidentiality and resilience. Each QR code contains a fragment of the encrypted payload and associated metadata, allowing the system to reassemble the data in an order-independent manner. Redundancy and error-correction mechanisms ensure that the dataset can still be reconstructed even if some QR codes are missing, damaged, or improperly scanned. Such functionality could not realistically be performed by human operators, as manual fragmentation, labeling, and reassembly of encrypted data at scale would be infeasible, error-prone, and incapable of maintaining the precision demanded by modern digital systems. By automating these functions, the system achieves a technological improvement in secure data management while addressing the limitations of Optical Character Recognition (OCR), which is prone to inaccuracies when translating printed text into digital code.

Furthermore, the system enhances data integrity by generating a cryptographic hash of the original payload and recording the hash on a blockchain ledger. This step creates a decentralized, tamper-proof reference that serves as an immutable authenticity check. Even if data is intercepted, altered, or re-encoded, any discrepancy will be immediately apparent by comparing the reconstructed payload's hash against the blockchain record. Because hashes are compact strings of fixed size, they are computationally efficient to generate and cost-effective to store, making them ideal for use on public blockchains where storage of large files is impractical or prohibitively expensive. By separating data storage from hash verification, the system achieves both scalability and efficiency while still ensuring trust in the integrity of the data. This approach goes beyond what human reviewers or conventional systems can accomplish, as no manual or centralized audit trail could offer the same level of immutability, transparency, and verifiability.

The system further employs asymmetric encryption to secure sensitive data from its point of origin through to retrieval. Public keys are used to encrypt the data before QR encoding, and only recipients with the correct private key can decrypt the reconstructed payload. This eliminates the need to share private keys between parties, reducing the attack surface and ensuring that sensitive information remains inaccessible to unauthorized actors. Even if adversaries capture partial QR fragments, without the private key and the proprietary reassembly algorithm, the dataset remains indecipherable. This architecture ensures confidentiality under real-world adversarial conditions where interception, partial corruption, or replay of data fragments may occur.

By combining these features, the disclosed system creates a secure, scalable, and verifiable mechanism for encoding, transmitting, and retrieving data across both analog and digital domains. Unlike conventional OCR-based methods or single-code QR encoding, the system provides resilience against data corruption, eliminates transcription errors, and introduces a blockchain-backed authenticity check that ensures the data is both accurate and unaltered. These technological improvements enable the reliable handling of complex data structures, such as hierarchical tables, JSON schemas, and large document sets, which cannot be securely managed by human processes or by existing encoding techniques.

Beyond encryption, various aspects of the present disclosure employ a proprietary function that scrambles and fragments the encrypted payload across multiple QR codes. This function applies deterministic partitioning rules and metadata labeling to each fragment so that the fragments can later be reassembled in a precise, order-independent manner. This fragmentation introduces both complexity and resilience: not only must the encrypted data be decrypted with the appropriate private key, but it must first be correctly reassembled through the proprietary scrambling algorithm. Without access to both elements, reconstruction of the payload is computationally infeasible.

This layered process ensures that intercepting one or more partial QR codes yields no usable information. Unlike conventional single-code QR encoding, where a compromised code may expose the entire payload, the fragmented distribution ensures that each QR code only represents a meaningless fraction of the whole dataset. Even with advanced computing resources, unauthorized parties cannot recreate the original encrypted payload without both the complete set of QR fragments and knowledge of the scrambling function.

Once the fragments are captured and correctly reassembled by the intended recipient, the encrypted payload can then be decrypted using the recipient's private key. This dual dependency—proprietary reassembly plus asymmetric decryption—creates a multi-layered security framework that provides confidentiality, integrity, and resilience against interception. In addition, the fragmentation process introduces redundancy and error correction such that data can still be reconstructed even if certain fragments are missing, corrupted, or damaged.

This approach represents a technological improvement over existing QR-based methods and conventional encryption alone, which typically rely on single-message payloads or do not incorporate fragmentation. By combining scrambling, fragmentation, and encryption into an integrated workflow, the disclosed system provides a robust defense against unauthorized access, brute-force reconstruction, and data corruption, thereby ensuring secure and verifiable handling of sensitive information across diverse transmission environments.

Conventional digitization methods, such as Optical Character Recognition (OCR), are often prone to errors when attempting to convert complex human-readable forms into machine-readable formats. OCR systems rely on pattern recognition of printed characters, which can be disrupted by font variations, image quality, misalignment, or artifacts such as smudges and handwriting. These factors frequently lead to incorrect character recognition, misplaced fields, or incomplete data capture. Such limitations are particularly problematic when processing structured data that requires precise formatting, since even minor errors can render the data unusable or introduce inconsistencies that propagate through downstream systems.

Various aspects of the present disclosure circumvent these limitations by encoding data directly into QR codes, thereby bypassing the need for OCR altogether. Instead of requiring interpretation of printed symbols, the system enables direct analog-to-digital translation through machine-readable QR patterns that preserve the exact data payload. This ensures that data is captured and reconstructed with perfect fidelity, independent of font, layout, or print quality. The system further supports the encoding of complex data schemas, such as JSON or hierarchical table structures, where explicit key-value pairings and nested relationships are preserved within the QR encoding.

This direct encoding eliminates the ambiguity that arises in traditional printed forms, where the association between values and their corresponding fields may be unclear or subject to human misinterpretation. By contrast, when data is encoded as structured QR payloads, each field and its associated value are inherently bound together, allowing machine systems to decode the structure with accuracy and without human intervention. In this way, the disclosed system not only improves reliability and eliminates OCR-related errors, but also introduces a technological improvement that enables robust handling of complex and hierarchical datasets across analog and digital platforms.

Furthermore, various aspects of the present disclosure provide the ability to encode and decode complex data structures, such as nested tables with multiple levels of headers and rows, surpassing the capabilities of conventional OCR systems, which frequently break down when confronted with hierarchical information. OCR methods are typically limited to linear text recognition and lack a reliable way to preserve structural relationships within the data. By contrast, the disclosed technology guarantees accurate encoding and decoding of even the most intricate data without the need for manual correction. Each QR fragment can carry metadata to preserve schema information, ensuring that key-value relationships and hierarchical associations remain intact. Built-in error correction within the QR codes provides an additional safeguard, ensuring data completeness even if certain QR codes are missing or corrupted. The system's ability to process QR codes in any orientation or order further enhances robustness, enabling flawless retrieval across diverse operational environments, such as low-light conditions, partial scans, or high-throughput scanning stations.

A further advantage lies in the system's ability to drastically reduce both the physical and digital footprint required to store large datasets by encrypting and encoding them into multiple QR codes. Datasets that might traditionally require hundreds of printed pages, or consume substantial digital storage resources, can now be represented in a compact series of QR codes. This compression effect enables secure archiving and transmission of large volumes of information in a format that is easy to print, scan, and transport without specialized equipment.

This data condensation is especially beneficial in industries where storage space is constrained, whether for physical records, digital repositories, or hybrid systems that maintain both. For example, hospitals managing large volumes of patient records or financial institutions archiving regulatory documents can significantly reduce their storage requirements while ensuring compliance with strict data integrity mandates. Despite the compact nature of the QR code format, the system preserves fidelity through the use of QR error correction and redundancy, ensuring recovery even when some QR codes are lost, damaged, or degraded. Complex data structures are encoded with precision such that relationships within the dataset, including nested associations and cross-referenced key-value pairs, remain unambiguous and machine-readable. This ensures that the condensed representation does not sacrifice accessibility, accuracy, or security.

To further enhance data integrity and authenticity, various aspects of the present disclosure integrate blockchain technology, where cryptographic hash references for created forms, documents, or files are recorded on a public or private distributed ledger. This blockchain integration provides a verifiable and tamper-proof mechanism for tracking the lifecycle of data, including creation, updates, edits, and access events. Unlike centralized logging systems, which may be vulnerable to compromise or manipulation, the decentralized nature of blockchain ensures that authenticity checks are transparent and independently verifiable by all parties with access.

By recording only compact cryptographic hashes rather than full datasets, the system avoids the inefficiency and cost associated with storing large files on-chain, particularly in public blockchain environments where storage is resource-intensive. The blockchain instead functions as an immutable audit trail, providing decentralized trust without imposing heavy storage requirements. This approach ensures that data authenticity can be proven at any stage without revealing or duplicating the underlying sensitive information. As a result, the disclosed system delivers enhanced integrity, auditability, and cost-efficiency while maintaining strong security guarantees and reducing reliance on centralized authorities.

Various aspects of the present disclosure include a web- and desktop-accessible user interface (UI) that provides an intuitive, drag-and-drop environment for the creation and customization of forms, documents, contracts, invoices, and files. The UI is designed to support industry-standard templates, including ISO-compliant forms, while also offering flexibility for generating fully customized layouts. Through this interface, users can input structured and unstructured data, such as personal, medical, contractual, or financial details, and associate such information with corresponding fields in a precise and unambiguous manner. The interface may further include validation tools to enforce data formats, consistency checks, and schema mapping to ensure that input data aligns with predefined structures (e.g., JSON schemas or tabular hierarchies). By combining drag-and-drop functionality with backend validation and schema enforcement, the UI streamlines the process of data collection, organization, and management, providing a user-friendly yet technically robust framework adaptable across healthcare, finance, legal, and enterprise domains.

Following the creation of a form or file, the system applies asymmetric encryption to secure the input data prior to encoding. The encryption process uses public keys for encrypting payloads, ensuring that sensitive private keys never need to be exchanged between parties. This approach significantly reduces the attack surface for unauthorized access while ensuring confidentiality throughout the data lifecycle. Even in scenarios where encrypted payloads are intercepted or partially exposed, they remain computationally infeasible to decrypt without possession of the corresponding private key. This encryption layer protects data both at rest and in transit, delivering strong guarantees of confidentiality, integrity, and resilience against interception or replay attacks. Such features are particularly advantageous in handling sensitive information such as personal identifiers, medical histories, financial records, or binding contractual obligations, where confidentiality is paramount.

Once encrypted, the system distributes and encodes the payload into multiple QR codes using a proprietary fragmentation and labeling algorithm specifically designed for enhanced security and error tolerance. Each QR code is assigned a unique identifier and metadata that may include sequence tags, redundancy bits, or schema references, ensuring that the codes can be scanned and processed in any order. The algorithm incorporates error-correction features and redundancy so that the encrypted dataset can still be reassembled even if one or more QR codes are damaged, lost, or unreadable. The reassembly process relies on the embedded metadata to reconstruct the encrypted payload in its correct form, preserving its integrity for subsequent decryption. This combination of asymmetric encryption, multi-QR fragmentation, and intelligent reassembly provides a layered security model that is highly resistant to interception, data corruption, and environmental scanning challenges. By ensuring accurate reconstruction of encrypted payloads across varied real-world conditions, the disclosed system offers a technological improvement in both data security and reliability over existing QR-based or OCR-based solutions.

Various aspects of the present disclosure are designed to decode individual QR codes and seamlessly reassemble the encrypted payload using the proprietary algorithm. Each QR code fragment may carry embedded metadata, such as sequence identifiers or redundancy information, allowing the system to accurately reconstruct the encrypted dataset regardless of the order in which fragments are scanned. This reassembly process ensures correctness even when codes are scanned randomly, out of sequence, or when one or more fragments are initially unavailable. The redundancy mechanism further allows reconstruction in cases where fragments are corrupted or permanently lost. Once the encrypted payload has been fully reconstructed, decryption is performed using the recipient's private key, ensuring that only authorized users can recover the original information. The dual dependency on correct reassembly and asymmetric decryption provides layered protection against interception or tampering.

Once the data is decrypted, it is restored to its original format, whether plain text, structured JSON with nested relationships, or more complex file types such as PDFs, images, or spreadsheets. By retaining the structural integrity of the original data, the system eliminates the need for further manual correction or conversion steps. This flexibility allows the decrypted payload to integrate seamlessly into existing enterprise workflows, software applications, and databases. Because the reconstructed information is machine-readable and schema-preserving, it can be immediately processed, analyzed, or stored across a wide range of platforms and industries without compatibility issues, thereby ensuring interoperability.

Various aspects of the present disclosure also integrate blockchain technology to generate and store cryptographic hash references of key data events, such as creation, modification, or access. These hash references serve as immutable records, enabling the establishment of a verifiable and tamper-proof history of all interactions with the data. By storing only lightweight hash values instead of full datasets, the system avoids the inefficiency and prohibitive cost of storing large files on a blockchain, while still benefiting from decentralized trust and transparency. This integration ensures traceability and accountability across distributed environments without compromising confidentiality, as the underlying data remains encrypted and stored off-chain.

Some conventional systems for creating and verifying document digests focus on hashing the contents of a document to generate a digest for tamper detection. In such systems, the digest may be encoded into a barcode or QR code, but the functionality is limited to authenticity verification through hash comparison. In contrast, the present disclosure employs a fundamentally different workflow by encrypting payloads, fragmenting them across multiple QR codes, and enabling secure reassembly and decryption by authorized recipients. This approach addresses not only authenticity but also secure transmission and faithful transformation of complex datasets from printed analog forms to machine-readable formats. Hashing alone, as used in prior systems, does not prevent interception, provide multi-layered encryption, or enable efficient reconstruction of fragmented encrypted data.

Other conventional approaches apply digitally encoded seals to physical documents and use blockchain solely to verify content, authorship, or history. While these systems demonstrate blockchain-based authenticity checks, they lack the ability to securely fragment, transmit, and reconstruct complex encrypted payloads. In contrast, the present disclosure integrates blockchain hashing as one component of a broader architecture that includes asymmetric encryption and multi-QR fragmentation. Rather than relying on blockchain as the sole safeguard, the disclosed system ensures confidentiality through encryption, resilience through fragmentation and error correction, and authenticity through blockchain hashing. This multi-faceted approach represents a technological improvement that goes beyond verification of static documents, enabling secure, scalable, and interoperable transmission of complex datasets across analog and digital domains.

A further conventional framework, such as FoodSQRBlock, digitizes information from the food supply chain, records it in a blockchain, and makes it accessible through QR codes for consumer transparency. While effective for tracking agricultural products and improving visibility in supply chain logistics, FoodSQRBlock is narrowly focused on provenance and product history. It does not employ encryption, fragmentation, or reassembly techniques, nor does it address secure handling of complex datasets. Aspects of the present disclosure, by contrast, are directed to transforming encrypted data—including large and structured payloads—into QR-encoded analog representations that can be reliably converted back into machine-readable formats. This distinction highlights a technological improvement over FoodSQRBlock's blockchain-based traceability model, which does not contemplate secure encrypted data transmission or order-independent reassembly of fragmented payloads.

Similarly, the ARBoR system secures clinical reports by storing them in a centralized ledger and verifying authenticity through cryptographic hashing. Although ARBoR incorporates QR codes as identifiers for verifying report validity, its emphasis remains on centralized report verification rather than on secure, end-to-end encrypted data exchange. Aspects of the present disclosure extend beyond authenticity verification, integrating asymmetric encryption, multi-QR fragmentation, and blockchain hashing into a single architecture. This combination enables not only authenticity but also confidentiality, resilience against data loss, and error-free translation between analog QR-encoded forms and digital machine-readable structures. Thus, the disclosed system is technically distinct from ARBoR, which is limited to report validation within a centralized framework.

Another conventional approach involves encoding invoice data into QR codes for e-invoicing, typically using Base64 encoding. Such systems generally focus on storing and presenting a small set of data fields—such as VAT registration numbers, invoice identifiers, and timestamps—in a machine-readable format for compliance or auditing purposes. These systems, however, do not address encryption, fragmentation, or blockchain verification, and are not designed to securely handle complex or voluminous datasets. By contrast, various aspects of the present disclosure encrypt large and sensitive payloads, fragment them across multiple QR codes, and enable secure, redundant reassembly and decryption. The difference in scope and functionality is substantial: the disclosed system ensures confidentiality, error tolerance, and authenticity in ways that conventional e-invoicing QR systems do not contemplate.

In summary, various aspects of the present disclosure provide a unique and technically robust solution for secure data transmission, encoding, and retrieval using multiple QR codes in conjunction with asymmetric encryption and blockchain verification. The conventional systems discussed—document digest hashing, blockchain-based supply chain tracking, clinical report verification, and e-invoicing—address narrow problems of authenticity or transparency but fail to enable secure, encrypted, and scalable transformation of complex datasets between analog and digital forms. By combining encryption, fragmentation, error correction, and blockchain verification into a single workflow, the present disclosure delivers a technological improvement that ensures confidentiality, integrity, and interoperability, distinguishing it from the prior art.

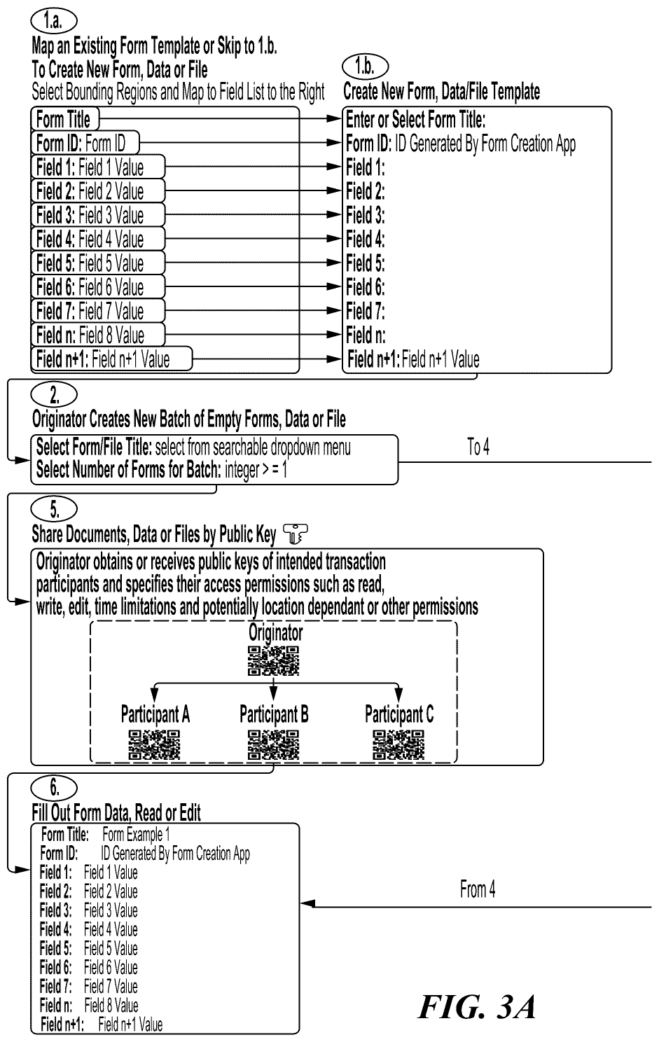

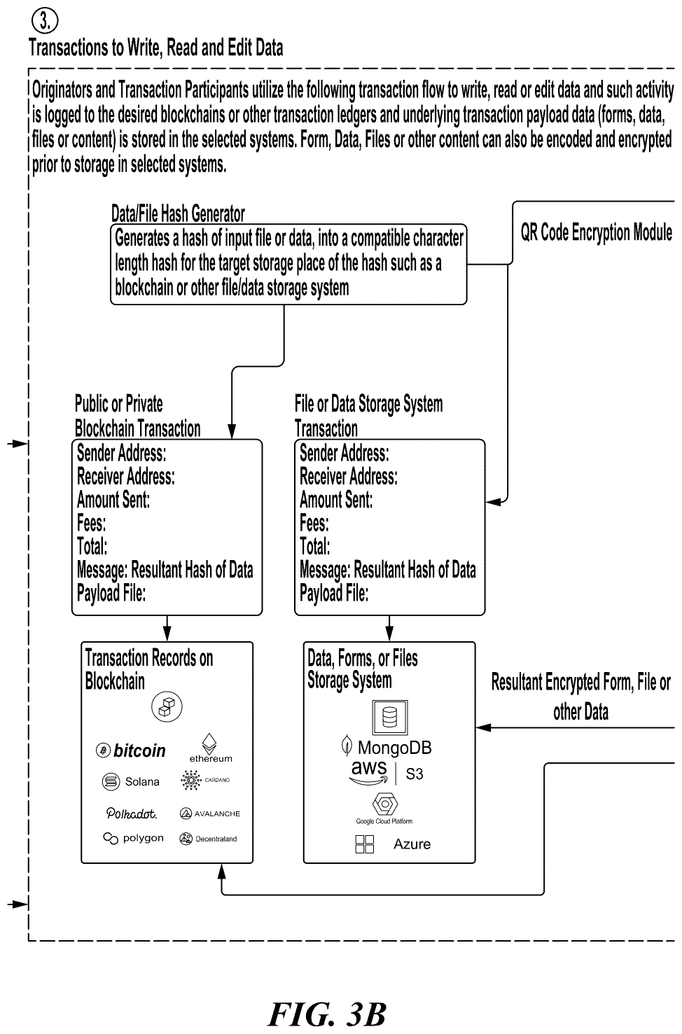

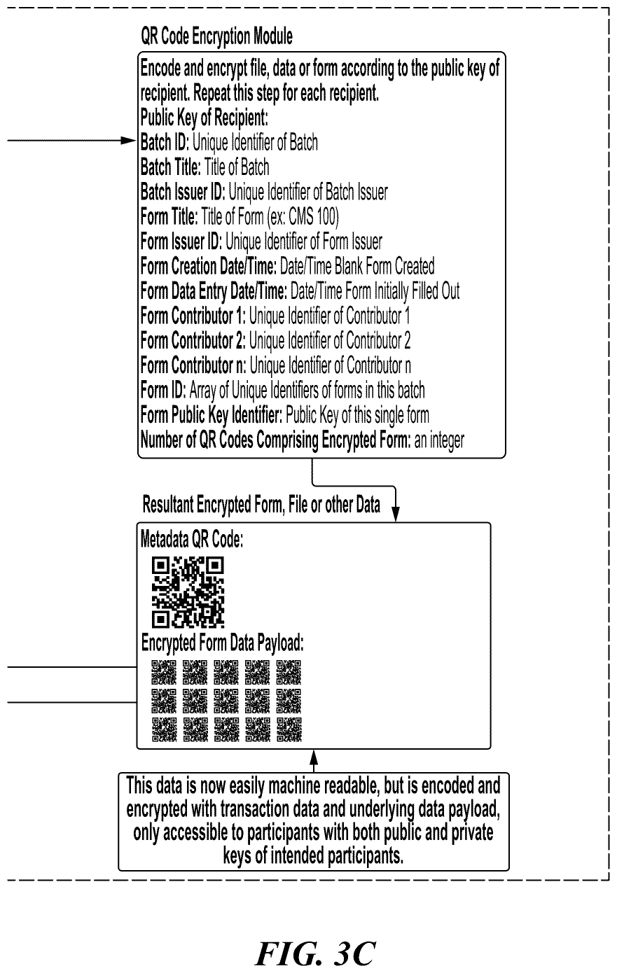

FIGS. 3A and 3B collectively illustrate an example workflow for securely creating, encrypting, encoding, sharing, and retrieving data, such as forms, documents, or files, using multiple QR codes and blockchain-based verification, in accordance with various aspects of the present disclosure. FIG. 3A emphasizes the user-facing operations for form creation, template mapping, batch generation, and participant sharing, while FIG. 3B expands on the backend processes for encryption, QR code fragmentation, hashing, blockchain integration, and secure storage.

As shown in FIG. 3A, the process may begin with block 1a, where a user selects and maps data fields onto an existing form template. This mapping step enables structured organization of information such as text entries, numeric identifiers, or field-specific values, ensuring that all input is captured in a machine-readable format. Alternatively, in block 1.b, the user may create a new form or file from scratch. In this scenario, the system generates a unique Form ID, assigns a title, and provides a customizable set of fields. The flexibility of this dual approach—either mapping to an existing template or creating a new one—ensures compatibility with standardized industry forms (e.g., ISO forms) as well as bespoke, domain-specific applications.

Once the template or new form is established, block 2 enables the originator to create a batch of empty forms or files. The batch is assigned metadata, including a form title, batch identifier, and information about the number of forms to be generated. The ability to handle forms in batches supports scalability for environments where large numbers of documents must be issued, such as hospitals, financial institutions, or government agencies. Each batch may include multiple participants, contributors, or fields, all of which are tied to the metadata recorded during this step.

Following batch creation, block 5 illustrates how the originator prepares forms or files for sharing by associating them with the public keys of intended participants. Each participant is represented in the system by a QR code linked to their public key, and the originator may specify corresponding access permissions. These permissions can include granular rights such as read-only access, editing privileges, or temporal and geographical restrictions on use. By assigning these access policies in advance, the system enforces security requirements while maintaining flexibility for collaboration.

At block 6, participants may access, fill out, or edit the form data. When a participant scans the QR code associated with the encrypted form, the system automatically retrieves the encrypted payload, reassembles it using the proprietary fragmentation algorithm, and validates it against the permissions assigned by the originator. Only authorized participants with the appropriate private keys are able to decrypt and view the underlying data. Once decrypted, the form is displayed in its original structured format, ensuring that participants can input or modify values securely and accurately without the need for additional manual processing.

Turning to FIG. 3B, the workflow advances to the backend operations for secure encoding, encryption, and verification of the data. At block 3, the Data/File Hash Generator produces a cryptographic hash of the input data. This hash serves as a unique digital fingerprint of the payload and is used to guarantee that any subsequent modifications to the data can be detected. The QR Code Encryption Module then encrypts the data with the recipient's public key and distributes the encrypted payload across multiple QR codes. Each QR code contains a portion of the encrypted data as well as associated metadata, such as batch identifiers, contributor IDs, and form titles, which enable the order-independent reassembly of the payload. The fragmentation ensures that interception of any subset of QR codes does not yield usable information, as both reassembly metadata and the corresponding private key are required to recover the dataset.

FIG. 3B also shows how the system integrates blockchain technology for authenticity verification. Once the encrypted data is fragmented into QR codes, the hash generated at block 3 is recorded on a blockchain transaction. Importantly, the blockchain stores only the cryptographic hash and not the underlying dataset, ensuring that sensitive information remains off-chain while still benefiting from decentralized trust and immutability. The blockchain thus serves as a tamper-proof ledger for recording the creation, update, or access history of the data, enabling any party with access to independently verify its authenticity. Multiple blockchain platforms may be supported, including public blockchains such as Bitcoin, Ethereum, Solana, and Polkadot, or private blockchain environments for enterprise deployments.

In parallel with blockchain recording, the encrypted data itself is stored in a secure, distributed data repository such as AWS S3, Microsoft Azure, or MongoDB. This hybrid approach leverages the efficiency of cloud storage for handling large encrypted datasets, while using blockchain to maintain a verifiable and immutable audit trail. The visual depiction in FIG. 3B shows the resulting encrypted form or file represented as an array of QR codes. A metadata QR code encapsulates key identifiers, while the data payload is spread across multiple QR fragments. These QR codes are machine-readable, resilient to errors, and can be scanned in any order, allowing authorized recipients to reconstruct the encrypted dataset, verify its authenticity against the blockchain hash, and decrypt it with their private key.

Together, FIGS. 3A, 3B, and 3C illustrate the interplay between user-facing functionality and backend cryptographic security. FIG. 3A illustrates the intuitive interface for form creation, participant sharing, and secure data entry, while FIGS. 3B and 3C illustrate the underlying encryption, fragmentation, error correction, blockchain verification, and distributed storage that ensure confidentiality, integrity, and reliability. The integration of these processes provides a secure, scalable, and verifiable system for handling sensitive data across analog and digital domains.

In various aspects of the present disclosure, the proprietary algorithm for encoding and retrieving data operates by fragmenting an encrypted payload into smaller units that can be individually represented as QR codes. In one example, the payload is divided into fixed-size fragments, each of which is supplemented with metadata such as a sequence identifier, error-correction code, and checksum. The metadata ensures that fragments may be correctly reassembled regardless of the order in which the QR codes are scanned, and allows corrupted fragments to be identified and discarded. In another example, the fragmentation process is randomized according to a seed value that is itself encrypted and distributed across one or more fragments. This randomized approach increases security by preventing adversaries from predicting the fragmentation pattern, while still allowing authorized users to reconstruct the dataset once the correct key and algorithm are available.

During reassembly, the system collects available QR codes, validates each fragment against its checksum or hash, and uses the sequence identifiers to restore the encrypted payload to its original form. Error-correction algorithms, such as Reed-Solomon coding or erasure codes, may be applied to enable reconstruction even when some QR codes are missing, unreadable, or damaged. Only after the payload has been successfully reassembled is decryption attempted using the intended recipient's private key. This ensures that interception of partial fragments does not yield usable information and that decryption cannot occur until the entire payload has been reconstructed correctly.

Alternative examples of the disclosed system may employ different cryptographic and encoding schemes. In one example, asymmetric encryption such as RSA or elliptic-curve cryptography is used exclusively, while in another example, a hybrid approach is employed: the payload is encrypted using a symmetric algorithm such as AES for efficiency, and the symmetric key is itself encrypted with the recipient's public key. In yet another example, lightweight encryption algorithms optimized for mobile or IoT devices may be substituted to reduce computational overhead.

Similarly, while QR codes are described as the primary encoding medium, alternate examples may use other machine-readable formats such as DataMatrix codes, Aztec codes, or high-capacity barcodes. These alternatives may be preferable in environments with limited printing space, higher density requirements, or specific scanner compatibility needs. The algorithm described above is adaptable across these encoding formats, as the fragmentation and labeling process is agnostic to the underlying symbology.

With respect to data integrity, the system may use different hashing algorithms depending on security or performance requirements. In one example, SHA-256 is employed for blockchain integration, while in other examples, SHA-3, BLAKE2, or a Merkle tree structure may be used to allow incremental verification of large datasets. The blockchain ledger may be public, private, or permissioned. In some examples, distributed ledgers without proof-of-work consensus may be utilized to reduce energy consumption and latency, particularly in enterprise or governmental environments.

Further, alternate examples contemplate variations in storage architecture. In one configuration, encrypted fragments are stored locally on a secure device, while hashes are written to a blockchain for verification. In another configuration, encrypted fragments are uploaded to a cloud storage system such as AWS, Azure, or IPFS, while only the cryptographic hashes are committed to the blockchain. In yet another example, fragments are distributed across peer-to-peer storage networks, with blockchain integration used to provide decentralized authenticity guarantees.

Through these variations, the system provides a flexible architecture that can be tailored to different security levels, performance requirements, and application domains.

Whether used in healthcare to securely encode patient charts, in finance to encode contracts, or in logistics to encode bills of lading, the algorithm ensures that encrypted data is fragmented, distributed, and reassembled in a manner that balances security, reliability, and efficiency.

In one example, a method is provided for securely encoding and encrypting data using QR codes. The method includes receiving input data from a user through a form, file, or application interface. The input data may include structured or unstructured information, such as personal, medical, contractual, or financial records. The method further includes encrypting the input data using asymmetric encryption, wherein a public key is applied to create an encrypted payload that can only be decrypted by a recipient possessing the corresponding private key. Once encrypted, the payload is fragmented into multiple data segments according to a fragmentation algorithm. Each data segment is then encoded into a corresponding QR code, and each QR code is assigned a unique identifier, such as a sequence number, batch identifier, or checksum, to facilitate subsequent tracking, order-independent scanning, and reassembly.

In another example, the method may further include generating a cryptographic hash of the input data using a secure hashing algorithm such as SHA-256, SHA-3, or BLAKE2. The cryptographic hash functions as a unique digital fingerprint of the original payload. The method then stores the generated hash on a public or private blockchain, such as Ethereum, Bitcoin, Hyperledger, or another distributed ledger system, to provide a decentralized, tamper-proof record of authenticity. The blockchain record may be used at any later point to verify that the data has not been altered or compromised.

In some examples, the method also includes storing the QR codes containing the encrypted data segments in a distributed storage system, such as a cloud storage service (e.g., AWS S3, Microsoft Azure, Google Cloud, or MongoDB). Each QR code may be associated with metadata, including the encryption method employed, the identity of the originator, timestamps, or other contextual details. This metadata enhances traceability, facilitates secure retrieval, and provides a robust audit trail for compliance.

Another example provides a method for securely sharing and accessing encrypted data using QR codes. The method includes receiving a request to share an encrypted data file from an originator, obtaining or generating a public key for each intended recipient, and encrypting the payload using the recipients'keys. The encrypted payload is then distributed across QR codes, which are transmitted to the intended recipients via secure communication channels, whether digital or analog (e.g., printed QR codes). To verify integrity upon receipt, each recipient may generate a new cryptographic hash of the reconstructed payload and compare it against the hash previously stored on the blockchain. Any discrepancy signals potential tampering or corruption.

In one variation of the above, the recipients decode the QR codes by scanning them in any order, and the system reassembles the encrypted data segments into the complete encrypted payload using the metadata. Once the payload is reconstructed, it is decrypted using the recipient's private key. The decrypted data is then presented in its original form, whether plain text, structured JSON, hierarchical tables, or file formats such as PDFs, spreadsheets, or images. The system may further allow authorized recipients to view, edit, or update the data, with any changes generating a new hash that can also be stored on the blockchain to record the updated state.

The disclosure also provides a method for error-tolerant retrieval of encrypted data from QR codes. The method includes scanning one or more QR codes containing encrypted data segments, applying an error-correction mechanism such as Reed-Solomon coding, erasure coding, or parity-check schemes to recover missing or damaged fragments, and reassembling the recovered fragments into the complete encrypted payload. After successful reassembly, the method decrypts the payload using the appropriate private key to retrieve the original data. This error-tolerant design allows the system to maintain reliability even in real-world conditions where some QR codes may be partially obscured, damaged, or lost.

In another example, the system automatically generates a batch of forms or files, wherein each form or file is associated with encrypted data that is encoded into multiple QR codes. The batch may be assigned a unique batch identifier for efficient organization, tracking, and retrieval across multiple users or documents.

A further example provides a method for verifying data authenticity using blockchain. This method includes generating a cryptographic hash of the encrypted payload, storing the hash on a blockchain to create a decentralized and tamper-proof record of the payload's creation, and comparing the blockchain-stored hash with a newly generated hash upon retrieval or access to verify authenticity and integrity.

In some implementations, the method also includes retrieving and verifying updates or modifications to the encrypted data by tracking blockchain records. Authorized users can trace the full history of interactions with the data—including creation, access events, and edits—thereby ensuring accountability and transparency across all stages of the data lifecycle. This capability ensures that the system does not merely protect the confidentiality of data but also provides verifiable authenticity and a permanent audit trail, features not present in conventional QR or OCR-based systems.

As discussed, various aspects of the present disclosure are directed to securely encoding, transmitting, and retrieving data using QR codes. In some examples, input data is encrypted using asymmetric encryption, such as RSA or elliptic-curve cryptography, to generate an encrypted data payload that can only be decrypted by an authorized recipient holding the corresponding private key. The encrypted data payload is then fragmented into a plurality of data segments, which are encoded into corresponding QR codes to generate a plurality of QR codes. Each QR code is assigned a unique identifier, such as a sequence number, hash value, or batch tag, that facilitates tracking, organization, and reassembly of the encrypted payload. Upon retrieval, the plurality of QR codes may be scanned in any order, and the encrypted data payload is reassembled based on the unique identifiers. The reassembled payload is then decrypted using the recipient's private key, thereby recovering the original input data in its correct and unaltered form.

In some implementations, a cryptographic hash of the encrypted data payload is generated using a secure hashing algorithm such as SHA-256, SHA-3, or BLAKE2. The hash may be stored on a public blockchain such as Ethereum or Bitcoin, or on a private or permissioned blockchain such as Hyperledger, thereby creating a decentralized and tamper-proof record of the encrypted payload. Storing only the hash, rather than the payload itself, ensures that data authenticity and integrity can be verified at any point without the cost or inefficiency of storing large datasets on the blockchain.

In additional implementations, a group of QR codes containing the encrypted data segments may be stored in a distributed storage system, such as a cloud-based service (e.g., AWS S3, Azure, Google Cloud) or a peer-to-peer storage network. Each QR code may be associated with metadata including one or more of: an identifier of the originator of the data, details of the encryption method used, a timestamp of generation, or a batch identifier linking multiple related forms or files. This metadata provides an additional layer of traceability and organization, enabling efficient retrieval and auditability.

In further aspects, the encrypted data may be securely shared. An originator may request to share the encrypted payload with one or more intended recipients, where the plurality of QR codes is transmitted via digital or analog means. Each recipient may then verify the integrity of the received payload by generating a hash of the reassembled data and comparing it with the reference hash stored on the blockchain. If the hashes match, the recipient is assured that the data has not been tampered with. The recipient can then scan the plurality of QR codes in any order, reassemble the encrypted payload using the identifiers, and decrypt the reassembled payload with their private key. Once decrypted, the recipient may access the data in its original format, such as plain text, JSON, spreadsheets, PDFs, or images, for purposes of viewing, editing, or updating.

Various aspects further contemplate error-tolerant retrieval. In real-world conditions where QR codes may be damaged, obscured, or lost, the system may use error-correction mechanisms, such as Reed-Solomon codes or erasure coding, to recover missing or corrupted data segments. The recovered data segments can be combined with available segments to reconstruct the complete encrypted payload for decryption. This ensures robustness and resilience in environments where perfect scanning cannot be guaranteed.

Additional aspects provide for batching and tracking of forms or files. The system may automatically generate a batch of forms, each associated with encrypted data that is distributed across one or more QR codes. A unique batch identifier may be applied to the forms or files, enabling organization and retrieval at scale across multiple users, documents, or transactions. This feature supports high-volume use cases, such as healthcare institutions managing patient records, financial organizations managing contracts, or logistics systems managing bills of lading.

FIG. 4 is a flow diagram illustrating an example of a process 400 for securely encoding, transmitting, and retrieving data using multiple QR codes, in accordance with various aspects of the present disclosure. The process 400 may be performed by a QR module 260 described with reference to FIG. 2. As shown in FIG. 4, the process 400 begins at block 402 by encrypting input data using asymmetric encryption to generate an encrypted data payload. At block 404, the process 400 fragments the encrypted data payload into a plurality of data segments. At block 406, the process 400 encodes each of the plurality of data segments into a corresponding QR code. At block 408, the process 400 assigns a unique identifier to each QR code to facilitate tracking and reassembly. At block 410, the process 400 reassembles the encrypted data payload from the plurality of QR codes upon retrieval. At block 412, the process 400 decrypts the reassembled encrypted data payload using a private key associated with an intended recipient to recover the original input data.

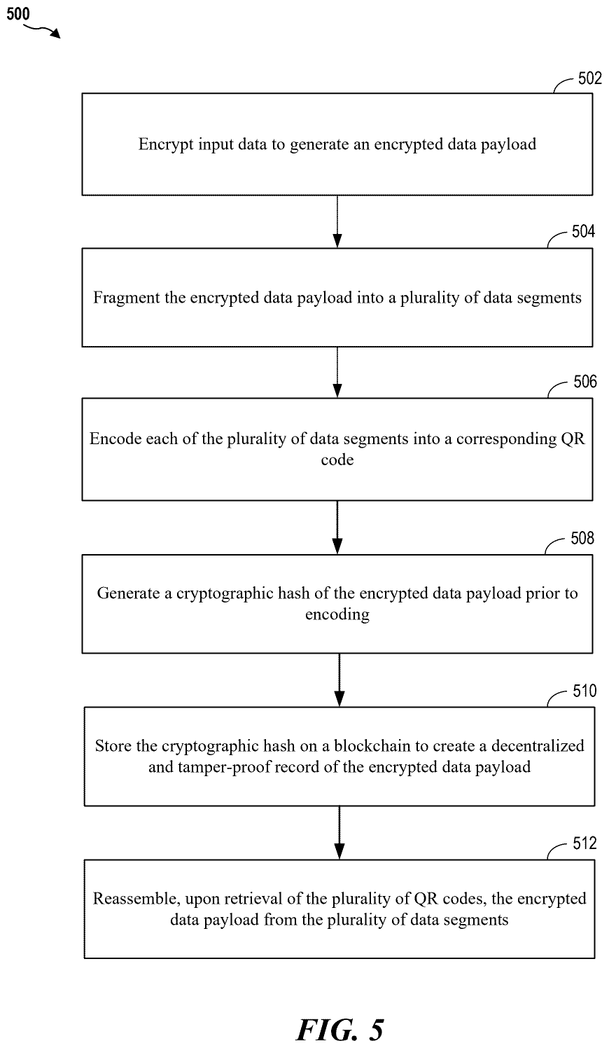

FIG. 5 is a flow diagram illustrating an example of a process 500 for securely encoding, transmitting, and verifying the authenticity of data using multiple QR codes and blockchain technology, in accordance with various aspects of the present disclosure. The process 500 may be performed by a QR module 260 described with reference to FIG. 2.

The process 500 begins at block 502 by encrypting input data to generate an encrypted data payload. At block 504, the process 500 fragments the encrypted data payload into a plurality of data segments. At block 506, the process 500 encodes each of the plurality of data segments into a corresponding QR code. at block 508, the process 500 generates a cryptographic hash of the encrypted data payload prior to encoding. At block 510, the process 500 stores the cryptographic hash on a blockchain to create a decentralized and tamper-proof record of the encrypted data payload. At block 512, the process 500, reassembles, upon retrieval of the plurality of QR codes, the encrypted data payload from the plurality of data segments. In some examples, the process 500 may also generate a new cryptographic hash of the reassembled encrypted data payload, and then compare the new cryptographic hash with the stored cryptographic hash on the blockchain to verify authenticity and integrity of the reassembled encrypted data payload.

As used herein, the term “determining”encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining”may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, the term “and/or” is intended to be inclusive and covers any and all combinations of one or more of the associated listed items. For example, the phrase “A, B, and/or C” means A alone, B alone, C alone, A and B together, A and C together, B and C together, or A, B, and C together.

As used herein, the term “real-time” refers to operations, processing, or responses that occur substantially concurrently with one or more system inputs, user interactions, or external events, such that the output or effect is provided with minimal delay relative to the triggering condition. “Real-time” does not necessarily require instantaneous execution but denotes a time frame that is fast enough to be perceived as immediate or actionable for the intended use case. For example, a “real-time design update” may involve adjusting a vehicle geometry during an optimization loop in response to evaluation results from a prior iteration, without waiting for completion of the entire design cycle.

As used herein, the term “dynamic” refers to a process, configuration, or behavior that is capable of changing, adapting, or being modified during operation, in contrast to a static or fixed approach. For example, “dynamic constraints” may be modified at runtime based on evaluation feedback, user input, or system-detected conditions. A “dynamic model” may update its parameters, structure, or inputs in response to new data, system state, or performance criteria.

As used herein, “artificial intelligence” or “AI” refers broadly to computational techniques, systems, or models that are capable of performing tasks typically associated with human intelligence, including but not limited to pattern recognition, natural language understanding, decision-making, reasoning, prediction, and perception. AI may encompass rule-based systems, symbolic reasoning, probabilistic models, and machine learning techniques such as supervised learning, unsupervised learning, reinforcement learning, and deep learning. In some examples, AI may include or be implemented using machine learning models such as artificial neural networks, transformer-based architectures, or ensemble systems. AI systems may be configured to adapt or improve their performance over time through training, fine-tuning, or interaction with users or external environments.

As used herein, a “machine learning model” or “model” refers to a computational model or set of models configured to learn patterns, relationships, or mappings from data through one or more training processes. A machine learning model may include, but is not limited to, artificial neural networks (ANNs), convolutional neural networks (CNNs), recurrent neural networks (RNNs), transformer-based models, support vector machines (SVMs), decision trees, random forests, or ensemble learning architectures. The machine learning model may be implemented using one or more layers of interconnected nodes or processing units that transform input features into output predictions or classifications through a series of learned weights and activation functions.

In some examples, the machine learning model is trained using supervised learning, where labeled training data includes known input-output pairs. In other examples, the model may be trained using unsupervised, semi-supervised, or reinforcement learning techniques. Training may be performed offline on pre-collected datasets, or continuously in an online learning context. The training process may involve optimizing a loss function that quantifies error or deviation between predicted outputs and expected values, using optimization methods such as stochastic gradient descent or its variants.

The machine learning model may be executed by one or more processors and may be stored in non-transitory memory. In some examples, a trained machine learning model may be deployed in an inference mode to receive input data (e.g., a three-dimensional design representation or performance metrics), and to generate output data (e.g., design transformations, predicted performance, or similarity scores) without further model modification. The model may be updated periodically or retrained as new training data becomes available, enabling the system to improve performance over time or adapt to changes in design criteria, manufacturing processes, or consumer preferences.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface.

Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for securely encoding, transmitting, and retrieving data using QR codes, comprising:
encrypting input data using asymmetric encryption to generate an encrypted data payload;
fragmenting the encrypted data payload into a plurality of data segments;
encoding each of the plurality of data segments into a corresponding QR code to generate a plurality of QR codes;
assigning a unique identifier to each QR code of the plurality of QR codes to facilitate tracking and reassembly;
reassembling the encrypted data payload from the plurality of QR codes upon retrieval; and
decrypting the reassembled encrypted data payload using a private key associated with an intended recipient to recover the input data.

2. The method of claim 1, further comprising:
generating a cryptographic hash of the encrypted data payload; and
storing the cryptographic hash on a public or private blockchain.

3. The method of claim 1, further comprising:
storing the plurality of QR codes in a distributed storage system, comprising a cloud-based storage service; and
associating metadata with each QR code, the metadata including at least one of: an identifier of an originator, encryption details, a timestamp, or a batch identifier.

4. The method of claim 1, further comprising:
receiving, from an originator, a request to share the encrypted data payload with one or more recipients;
transmitting the plurality of QR codes to the one or more recipients; and
verifying, by each of the one or more recipients, integrity of the encrypted data payload by comparing a cryptographic hash generated from the reassembled encrypted data payload with the cryptographic hash stored on a blockchain.

5. The method of claim 4, wherein:
each of the one or more recipients:
decodes the plurality of QR codes by scanning the plurality of QR codes in any order,
reassembles the encrypted data payload using the unique identifiers,
decrypts the reassembled encrypted data payload using a corresponding private key, and
accesses the decrypted data in its original format for viewing, editing, or updating.

6. The method of claim 1, further comprising:
scanning one or more of the plurality of QR codes containing encrypted data segments;
using an error-correction mechanism to recover data segments; and
reassembling the recovered data segments with available data segments into the encrypted data payload for decryption with the private key.

7. The method of claim 6, further comprising:
generating a batch of forms or files, each associated with one or more QR codes; and
applying a unique batch identifier to the forms or files.

8. An apparatus for securely encoding, transmitting, and retrieving data using QR codes, comprising:
one or more processors; and
one or more memories coupled with the one or more processors and storing processor-executable code that, when executed by the one or more processors, is configured to cause the apparatus to:
encrypt input data using asymmetric encryption to generate an encrypted data payload;
fragment the encrypted data payload into a plurality of data segments;
encode each of the plurality of data segments into a corresponding QR code to generate a plurality of QR codes;
assign a unique identifier to each QR code of the plurality of QR codes to facilitate tracking and reassembly;
reassemble the encrypted data payload from the plurality of QR codes upon retrieval; and
decrypting the reassembled encrypted data payload using a private key associated with an intended recipient to recover the input data.

9. The apparatus of claim 8, wherein execution of the processor-executable code further causes the apparatus to:
generate a cryptographic hash of the encrypted data payload; and
store the cryptographic hash on a public or private blockchain.

10. The apparatus of claim 8, wherein execution of the processor-executable code further causes the apparatus to:
store the plurality of QR codes in a distributed storage system, comprising a cloud-based storage service; and
associate metadata with each QR code, the metadata including at least one of: an identifier of an originator, encryption details, a timestamp, or a batch identifier.

11. The apparatus of claim 8, wherein execution of the processor-executable code further causes the apparatus to:
receive, from an originator, a request to share the encrypted data payload with one or more recipients;
transmit the plurality of QR codes to the one or more recipients; and
verify, by each of the one or more recipients, integrity of the encrypted data payload by comparing a cryptographic hash generated from the reassembled encrypted data payload with the cryptographic hash stored on a blockchain.

12. The apparatus of claim 11, wherein:
each of the one or more recipients:
decodes the plurality of QR codes by scanning the plurality of QR codes in any order,
reassembles the encrypted data payload using the unique identifiers,
decrypts the reassembled encrypted data payload using a corresponding private key, and
accesses the decrypted data in its original format for viewing, editing, or updating.

13. The apparatus of claim 8, wherein execution of the processor-executable code further causes the apparatus to:
scan one or more of the plurality of QR codes containing encrypted data segments;
use an error-correction mechanism to recover data segments; and
reassemble the recovered data segments with available data segments into the encrypted data payload for decryption with the private key.

14. The apparatus of claim 13, wherein execution of the processor-executable code further causes the apparatus to:
generate a batch of forms or files, each associated with one or more QR codes; and
apply a unique batch identifier to the forms or files.

15. A method for verifying data authenticity in a multi-QR code encryption system, comprising:
encrypting input data to generate an encrypted data payload;
fragmenting the encrypted data payload into a plurality of data segments;
encoding each of the plurality of data segments into a corresponding QR code to generate a plurality of QR code;
generating a cryptographic hash of the encrypted data payload prior to encoding;
storing the cryptographic hash on a blockchain to create a decentralized and tamper-proof record of the encrypted data payload; and
reassembling, upon retrieval of the plurality of QR codes, the encrypted data payload from the plurality of data segments.

16. The method of claim 15, further comprising:
generating a new cryptographic hash of the reassembled encrypted data payload; and
comparing the new cryptographic hash with the stored cryptographic hash on the blockchain to verify authenticity and integrity of the reassembled encrypted data payload.

17. The method of claim 16, further comprising:
recording, on the blockchain, cryptographic hashes corresponding to updates or modifications of the encrypted data payload following reassembly from the plurality of QR codes;
retrieving the recorded cryptographic hashes to verify the authenticity of the encrypted data payload by comparing a newly generated hash of the encrypted data payload with the recorded cryptographic hashes; and
providing authorized users with access to the blockchain to trace a history of interactions with the encrypted data payload, including creation, updates, and access events.
